(19) United States
(12) Patent Application Publication
(10) Pub. No.: US 2017/0120203 A1
(43) Pub. Date: May 4, 2017

(54) GAS SOURCE WITH REDUCED DUST CHARACTERISTICS FOR USE IN BEVERAGE MAKING

(71) Applicant: Keurig Green Mountain, Inc., Waterbury, VT (US)

(72) Inventors: Thomas J. Novak, Morristown, VT (US); Jennifer Caitlin Carlson, Essex Junction, VT (US); Matthew Elmer, Richmond, VT (US); Peter S. Given, JR., Stowe, VT (US); Peter Gosselin, Richmond, VT (US); Andrew Chamberlin, Underhill, VT (US); Caitlin Elizabeth LaClair, Stowe, VT (US)

(73) Assignee: Keurig Green Mountain, Inc., Waterbury, VT (US)

(21) Appl. No.: 15/050,783

(22) Filed: Feb. 23, 2016

Related U.S. Application Data
(60) Provisional application No. 62/247,789, filed on Oct. 29, 2015.

(51) Int. Cl. B01F 3/04; A23L 2/54

(52) U.S. Cl. CPC B01F 3/04801; A23L 2/54; A23V 2002/00; B01F 2003/049

(57) ABSTRACT

Molecular sieve beads, such as zeolite, used to adsorb and release gas for carbonating a beverage are coated with fumed and/or precipitated silica. Such coating may reduce dust otherwise produced by the beads without inhibiting the beads' ability to adsorb and release gas.

### CROSS REFERENCE TO RELATED APPLICATION

This application claims the benefit of U.S. Provisional Application No. 62/247,789, filed Oct. 29, 2015, which is hereby incorporated by reference in its entirety.

### BACKGROUND

The inventions described herein relate to dissolving gas in liquids, e.g., carbonation, for use in preparing a beverage. Systems for carbonating liquids and/or mixing liquids with a beverage medium to form a beverage are described in a wide variety of publications, including U.S. Pat. Nos. 4,025,655; 4,040,342; 4,636,337; 6,712,342 and 5,182,084; U.S. Patent Publication 2013/0129870 and PCT Publication WO 2008/124851.

### SUMMARY OF INVENTION

Aspects of the invention relate to carbonating or otherwise dissolving a gas in a precursor liquid, such as water, to form a beverage. In some embodiments, a carbon dioxide or other gas source can be provided in a cartridge which is used to generate carbon dioxide or other gas that is dissolved into the precursor liquid. In some embodiments, a beverage medium, such as a powdered drink mix or liquid syrup, may be provided in the same, or a separate cartridge as the gas source and mixed with the precursor liquid (either before or after carbonation) to form a beverage. The use of one or more cartridges for the gas source and/or beverage medium may make for an easy to use and mess-free system for making carbonated or other sparkling beverages, e.g., in the consumer's home. (The term “carbonation” or “carbonated” is used herein to generically refer to beverages that have a dissolved gas, and thus refers to a sparkling beverage whether the dissolved gas is carbon dioxide, nitrogen, oxygen, air or other gas or mixture of gases. Thus, aspects of the invention are not limited to forming beverages that have a dissolved carbon dioxide content, but rather may include any dissolved gas.)

In one aspect of the invention, a cartridge for use by a beverage forming machine in forming a beverage includes a container having a first chamber that is sealed and encloses a gas source material arranged to release a gas adsorbed in the gas source material, e.g., in response to the addition of a fluid introduced into the first chamber. The gas source material may be a solid molecular sieve, such as beads of a zeolite material that have adsorbed gas which is released in the presence of water or other fluid. The cartridge container may have an inlet through which fluid is introducible by a beverage forming machine into the first chamber to cause the gas source material to release the gas, and an outlet through which gas released by the gas source exits the first chamber for dissolution in a beverage. Gas that exits the cartridge may be mixed with a precursor liquid whereby the gas is dissolved or otherwise mixed with a precursor liquid to form a beverage.

In accordance with an aspect of the invention, the beads of solid molecular sieve may have a coating of fumed or precipitated silica particles at an outer surface of the beads. Such a coating may significantly reduce dust created by the beads, e.g., during transport, packaging, use in forming a beverage, etc., yet have little or no impact on the beads' ability to adsorb and release gas. Reducing dust can provide benefits, such as reducing particulate material that is released from the cartridge during gas production and potentially passed to a beverage to be carbonated. That is, uncoated beads of zeolite adsorbent release small particles or dust when physically disturbed or in other conditions and these small particles can be carried by released gas from the cartridge. The transported dust can be deposited in conduits, valves or other components of the beverage machine, or can be passed to the beverage itself. Although not harmful to the beverage consumer, the dust can clog machine conduits, create a cloudy beverage or cause other problems.

The inventors have found that not all forms of silica can be used to coat adsorbent beads while providing suitable adsorbency and dust reduction. Specifically, the inventors have found that fumed silica and precipitated silica particles perform particularly well, and that colloidal silicas and silicate compounds do not. For example, colloidal silicas and silicate compounds were found to reduce adsorbency without providing suitable dust reduction. It is believed, for example, that silicate compounds may penetrate the bead surface, inhibiting the transport of fluid through the bead surface. In contrast, fumed and precipitated silica coatings were found to reduce dust without significantly inhibiting the adsorbency of beads. In some embodiments, fumed and precipitated silica coatings provided dust reduction as measured by turbidity levels of 20 NTU or less (e.g., 10 NTU or less) along with adsorptive capacities of 10 to 15% or more by weight of the beads.

The coating of fumed or precipitate silica particles may be applied to beads in different ways. For example, the fumed or precipitate silica particles may be mixed with water and the combined water/silica sprayed or otherwise applied to adsorbent beads. In some cases, dry fumed or precipitate silica particles may be additionally applied to the beads after the beads are sprayed with the water/silica combination so as to apply additional silica particles to the wetted beads. In another embodiment, the beads may be first wetted with water alone, and dry fumed or precipitate silica particles applied to the water-only wetted beads. The dry silica particles may be applied by screening, shaking or sprinkling powder on beads, spraying the beads in a pan coater or other device, electrophoretic or electrostatic deposition (whether wet or dry), thermal or plasma spraying, or others. The silica coating applied at the outer surface of the beads may comprise 0.5% to 5.0% by weight of the bead. The coating may be applied at any suitable step in a process of forming the beads, such as after bead formation but before calcining/activation of the beads, after calcining/activation of the beads, or at other points. In some cases where the coating is applied after calcining/activation of beads, an additional drying, calcining and/or activation process may be necessary, e.g., to drive off water adsorbed by the beads. The beads may be caused to adsorb a carbonating gas after the coating process is complete so that the beads will later release the adsorbed gas in the presence of a suitable fluid, such as water.

Introduction of the fluid into a cartridge containing silica-coated, charged molecular sieve beads to cause the beads to release gas may be done in different ways, e.g., water may be injected into the sealed compartment via an inlet of the cartridge. In some cases, the cartridge may be pierced to form the inlet, or the cartridge may have a defined inlet port or other arrangement. In some embodiments, the gas source material may include beads of a charged zeolite. A “bead” as used herein refers to an object that may have a variety of different shapes, such as spherical, cylindrical, cuboid, capsule-shaped, and others. Also, in some embodiments, a bead has a ratio of a mass of adsorbed gas to a mass of the bead of at least 10 to 15%, and is arranged to release at least 95% of all adsorbed gas within 60 seconds when immersed in water. Thus, in these embodiments, a structure that does not have a ratio of adsorbed gas mass to bead mass of at least 10 to 15% and cannot release at least 95% of all adsorbed gas within 60 seconds of immersion in water is not a “bead.” For example, in some arrangements, a cartridge may include filler elements, such as uncharged zeolite masses that have a bead shape, in addition to charged zeolite beads, and the uncharged masses are not considered a “bead” since they have little or no adsorbed gas. Similarly, some zeolite particles in a cartridge that are unable to release adsorbed gas within 60 seconds of water immersion, and thus are not considered “beads.”

In some embodiments, the cartridge includes a mass of gas source material of 10-50 grams and a volume of less than 50 ml. Such amounts are suitable to carbonate a beverage, e.g., the 10-50 grams of gas source material may have an amount of adsorbed gas equivalent to a volume of 300 ml to 2000 ml of the gas at atmospheric pressure. This amount of gas may be suitable to carbonate a volume of water of 200-1000 ml to a level of about 1-5 volumes. The container in which the gas source material is contained may include a lid that is piercable by a beverage forming machine to form the inlet and outlet, i.e., an inlet for activating water or other fluid and an outlet for gas released from the gas source material. In one embodiment, the top of the cartridge container may be piercable to form the inlet and outlet of the first chamber, a sidewall may extend downwardly from the top, and a rim may extend outwardly from a lower end of the sidewall. The rim may provide a clamping surface for a beverage machine to engage the cartridge to create a seal and help maintain gas released from the cartridge under suitable pressure in a closed chamber in which the cartridge is at least partially held. A filter may be included in the first chamber to resist exit of gas source material from the outlet of the first chamber. For example, in some cases, small particles of gas source material may tend to be carried by the flow of gas from the cartridge. The filter may help resist exit of the entrained particles, thereby helping to resist the particles from being carried to the precursor liquid to be carbonated.

In some embodiments, a cartridge container may also include a second chamber that is separated from the first chamber, with the second chamber being sealed and containing a beverage medium for mixing with a precursor liquid to form a beverage. For example, the beverage medium may be a syrup or other concentrate that is mixed with a beverage precursor in, or outside of, the cartridge. The second chamber may be located below the first chamber, and the first and second chambers may be separated by a wall. In one embodiment, the container may include a top, an upper sidewall that extends downwardly from the top, a bottom, a lower sidewall that extends upwardly from the bottom, and a rim that extends outwardly from a lower end of the upper sidewall and an upper end of the lower sidewall. The top may be piercable to form the inlet and outlet, the rim may be piercable (e.g., at an underside or lower surface of the rim) to form an inlet opening to the second chamber through which to receive pressurized gas into the second chamber, and the bottom may include an outlet opening through which beverage medium exits the second chamber, e.g., in response to pressurized gas forcing the beverage medium to exit.

These and other aspects of the invention will be apparent from the following description and claims.

### BRIEF DESCRIPTION OF THE DRAWINGS

Aspects of the invention are described with reference to the following drawings in which like numerals reference like elements, and wherein:

FIG. 1 shows a perspective view of a cartridge in an illustrative embodiment;

FIG. 2 shows a cross sectional view of the FIG. 1 cartridge;

FIG. 3 shows a cross sectional view of a modified version of the FIG. 1 cartridge having only a gas source chamber;

FIG. 4 shows a side view of a beverage forming machine in an illustrative embodiment;

FIG. 5 shows the cross sectional view of the FIG. 1 cartridge with piercing elements engaged at the lid of the cartridge; and

FIG. 6 shows a schematic diagram of components of a beverage forming system in an illustrative embodiment.

### DETAILED DESCRIPTION

It should be understood that aspects of the invention are described herein with reference to the figures, which show illustrative embodiments. The illustrative embodiments described herein are not necessarily intended to show all embodiments in accordance with the invention, but rather are used to describe a few illustrative embodiments. For example, aspects of the invention are described with reference to a specific cartridge arrangement, but aspects of the invention are not limited to the cartridge arrangements described herein. Thus, aspects of the invention are not intended to be construed narrowly in view of the illustrative embodiments. In addition, it should be understood that aspects of the invention may be used alone or in any suitable combination with other aspects of the invention.

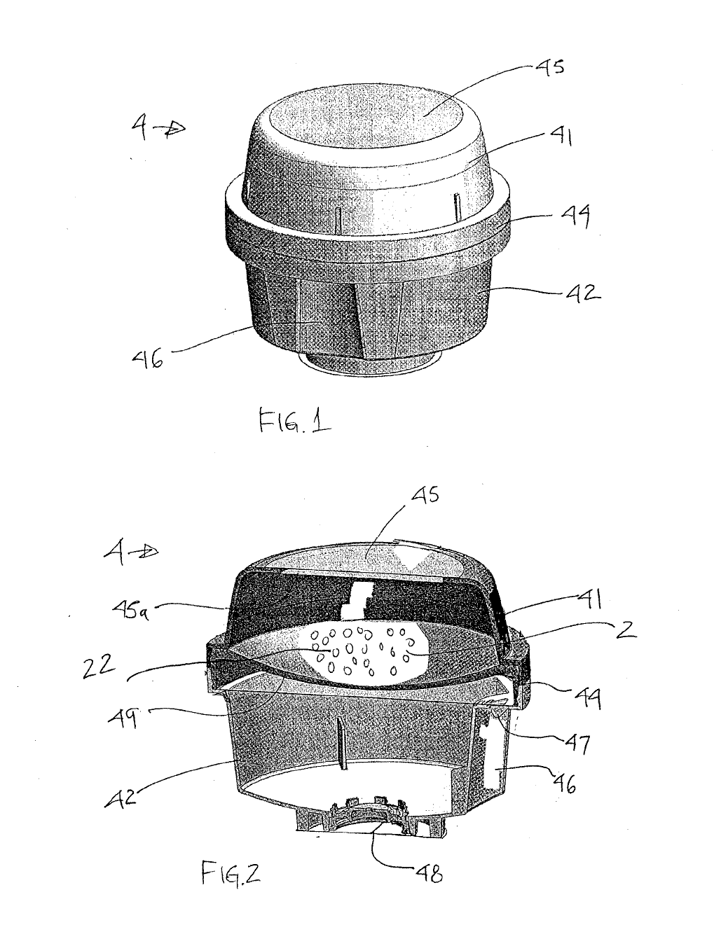

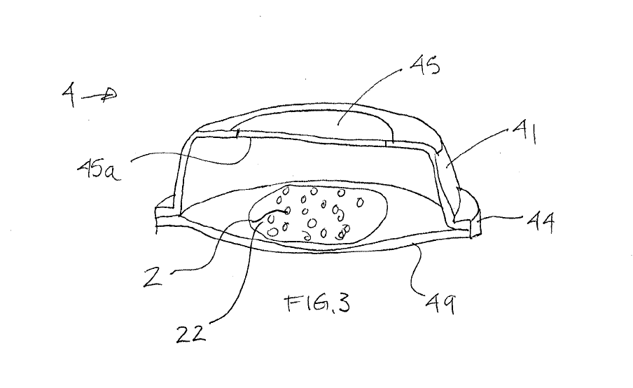

While alternative cartridge configurations are possible, FIGS. 1 and 2 show a cartridge 4 that may be used with a beverage making system that employs the cartridge to at least carbonate a beverage precursor liquid to form a beverage. In this embodiment, the cartridge 4 includes a container that defines an upper compartment or chamber 41, a lower compartment or chamber 42, and a rim or band 44 between a top and bottom of the cartridge 4. The top of the cartridge 4 includes a lid 45 that covers an opening of the container. The lid 45 is piercable to form one or more openings so as to access a gas source 2 (see FIG. 2) in the upper compartment 41. (Although in this embodiment, the lid 45 is a separate element, such as a sheet of foil/polymer laminate attached to the container body, the lid may be molded or otherwise formed integrally with the body.) Also, a filter 45a may be positioned below the lid 45, e.g., spaced apart from the lid 45 but parallel to the lid 45, although other arrangements are possible. This filter 45a may help prevent gas source material and/or other solid particles from exiting the upper compartment 41 during gas production. The upper compartment 41 is also defined in part by a wall 49 that has a concave up curve, but such a shape is not necessary, e.g., the wall 49 may be flat or concave down.

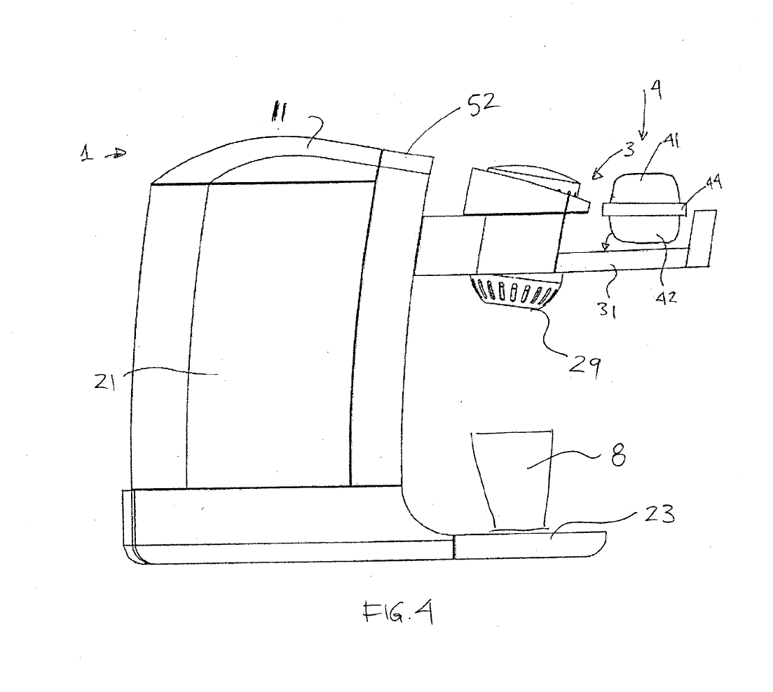

The lower compartment or chamber 42 contains a beverage medium (not shown for clarity) that can be mixed with a precursor liquid to form a beverage. A piercable inlet 47 may be located at an underside of the rim 44 and adjacent an indexing groove 46 formed in the lower sidewall of the cartridge 4. As is discussed in more detail below, the inlet 47 may be pierced to allow access to the lower compartment 42, e.g., so pressurized gas or liquid can be introduced into the lower compartment 42 to move the beverage medium out of an outlet 48 of the lower compartment 42. In this embodiment, the outlet 48 includes a piercable membrane that can be pierced and opened to allow the beverage medium to exit, although other arrangements are possible, e.g., a self-closing septum valve or burstable seal may be provided at the outlet 48 that opens with increased pressure in the lower compartment 48. Cartridges are not limited to the arrangement shown in FIGS. 1 and 2, however, and other cartridge configurations, such as those that include only a gas source (e.g., only a rim 44 and upper compartment 41 like that shown in FIG. 3) to make a carbonated water, are possible. In the case of FIG. 3, the wall 49 forms a bottom of the cartridge container from which the rim 44 extends outwardly. The wall 49, as noted above, may be flat, or otherwise shaped and need not have the shape shown.

In accordance with an aspect of the invention, the cartridge 4 contains a gas source material 2 in the form of a molecular sieve. That is, in this embodiment the gas source material 2 is a charged adsorbent or molecular sieve, e.g., a zeolite material that has adsorbed an amount of carbon dioxide gas that is released in the presence of water or other activating fluid, whether in vapor or liquid form. Note, however, that aspects of the invention are not necessarily limited to use with carbon dioxide gas, but may be used with any suitable gas, such as nitrogen, which is dissolved in some beers or other beverages, oxygen, air, and others. Thus, reference to “carbonation”, “carbon dioxide source” “carbon dioxide activating fluid supply”, etc., should not be interpreted as limiting aspects of the invention and/or any embodiments to use with carbon dioxide only. Instead, aspects of the invention may be used with any suitable gas.

In one embodiment, the charged adsorbent is a zeolite such as analcime, chabazite, clinoptilolite, heulandite, natrolite, phillipsite, or stilbite along with a suitable binder or filler component, e.g., to help form the zeolite into a desired shape. The zeolite may be naturally occurring or synthetic, and may be capable of holding up to about 20% carbon dioxide by weight or more. The zeolite material may be arranged in any suitable form, such as a solid block (e.g., in disc form), particles of spherical, cubic, irregular or other suitable shape, and others. In one aspect of the invention, the molecular sieve is arranged in the form of beads, e.g., that have a largest dimension of 0.5 mm to 2.5 mm

In accordance with an aspect of the invention, beads of molecular sieve may be coated with fumed or precipitated silica particles. The coating may help to reduce dust (very small particles) released by the beads during manufacture, transport, packaging and/or use. For example, in some embodiments the coating may provide the beads with a turbidity measurement of 20 NTU or less. According to this turbidity measurement, a mass of coated, charged beads (i.e., 25 grams of charged beads coated with silica particles) are immersed in 250 grams of reverse osmosis, distilled or deionized water contained in a 600 milliliter container so that the beads release adsorbed gas. Specifically, the 25 grams of charged beads are placed in the container and the 250 grams of water is poured into the container over the beads within about 3 seconds. Once all adsorbed gas is released by the beads, i.e., within about 45 seconds, the water in the container is decanted to separate the beads from the water. Samples of the decanted water are placed in sample containers used by a Hach 2100N Turbidimeter (Hach Company, Loveland Colo.). The turbidity of the water samples is then measured using a properly calibrated Hach 2100N Turbidimeter to provide a turbidity value for the coated beads. Multiple samples are measured, e.g., at least three samples, and the measurement results averaged to obtain an NTU value of turbidity. In some cases, uncoated zeolite beads have been found to have a turbidity value of about 50 NTU, whereas beads coated with fumed or precipitated silica particles have a turbidity value of 20 NTU or less, e.g., 10 NTU or less. This significantly reduced turbidity value can help reduce dust produced by the beads during packaging, use or other points in the lifecycle of beads.

Importantly, the coating of fumed or precipitated silica particles has been found to not impair the beads' ability to adsorb and release gas. For example, coated beads have been found to have an adsorptive capacity (i.e., a measure of a mass of gas adsorbed by the beads to the mass of the beads) of about 10-19%. (Adsorptive capacity is determined as a ratio of grams of adsorbed gas to grams of adsorbed gas plus grams of zeolite material). This is significant since the adsorptive capacity of the uncoated beads used to test silica coatings in accordance with aspects of the invention can be as high as about 19%. Thus, the coating of fumed or precipitated silica particles functions to reduce dust while allowing the beads to rapidly adsorb and release gas. For example, in some embodiments a ratio of a mass of adsorbed gas to a mass of the beads is at least 10 to 15%, and the beads are each arranged to release at least 95% of all adsorbed gas within 60 seconds when immersed in water.

The coating of fumed or precipitated silica particles may be relatively thin and provided at the outer surface of the beads. For example, weight of the coating of fumed or precipitated silica particles on each bead may be about 0.5% to 5.0% of a weight of the bead. Regarding fumed silica particles, commercially available products, such as AEROSIL 90 or 200, by Evonik Industries of Essen, Germany, have been found suitable for use. Such fumed silica particles may have a primary particle size between about 7 and 50 nm, and a surface area BET of 50 to 350 square meters/gram. (AEROSIL is a registered trademark of Evonik). Regarding precipitated silica particles, ZEOTHIX 177 by Huber Engineered Materials of Havre de Grace, Maryland has been found effective. (ZEOTHIX is a registered trademark of Huber.) Such precipitated silica particles have an average particle size of about 3.6 microns, and a surface area BET of about 180 square meters/gram.

The coating of fumed or precipitated silica particles may be applied to beads by mixing the fumed or precipitated silica particles with water and applying the mixture to beads and/or by applying dry fumed or precipitated silica particles to pre-wetted beads. For example, a suspension of about 0.015% by weight fumed or precipitated silica particles in water may be sprayed or otherwise applied to beads and the mixture allowed to dry, leaving a coating of fumed or precipitated silica particles on the beads. Note that higher weight percentages of silica to water may be used, e.g., up to about 5% or higher. Beads may be sprayed with the silica suspension, or the suspension may be otherwise applied, such that the beads are coated with silica to the 0.5% to 5% weight load described above. That is, silica suspension may be applied in amounts to achieve the desired loading of silica particles to the beads.

In another arrangement, in addition to or instead of having silica applied to the beads using a silica suspension, dry fumed or precipitated silica particles may be applied to the beads. Where beads are first treated with a silica suspension, the additional application of dry silica may effectively increase the amount of silica applied to the beads and/or reduce the amount of suspension needed to achieve a desired silica loading for beads. Where the beads are not first treated with a silica suspension, beads may be first sprayed or otherwise wetted with plain water, and then dry silica particles applied. The dry silica particles may be applied using any suitable technique, such as screening, shaking or sprinkling powder on beads, spraying the beads in a pan coater or other device, electrophoretic or electrostatic deposition (whether wet or dry), thermal or plasma spraying, or others.

After the application of silica particles, the coated beads may be calcined and dried, e.g., held in a crucible, the beads may be heated in a 200 degree C. furnace for 30 minutes, after which the temperature is ramped up to 500 degrees C. at a rate of 5 degrees C./minute to 30 degrees C./minute and held at 500 degrees C. for one hour. Of course, calcining and drying are not necessarily needed or could be done in other ways.

In one aspect of the invention, a method of forming beads of a molecular sieve for adsorbing gas to be dissolved in a beverage includes providing solid beads of a molecular sieve. The beads may have a largest dimension of 0.5 to 2.5 mm or other suitable size, and may be made of an aluminosilicate zeolite or other suitable molecular sieve. The beads may be coated with particles of fumed or precipitated silica, e.g., so that the coating functions to reduce dust that would otherwise be produced by the beads but without substantially impeding the ability of the beads to adsorb gas. For example, the coated beads may have a turbidity value of 20 NTU or less and an adsorption capacity of at least 10%, such as 13-17%. The beads may be coated with the silica particles by mixing the silica particles in an aqueous solution and applying the solution to the beads, e.g., by spraying, immersion, or other suitable process. The beads may thereafter have dry silica particles applied to provide further silica particles on the beads. Alternately, the beads may be wetted with plain water and dry silica particles applied, e.g., by dusting, sprinkling, electrostatic application, etc. The coating of the beads with silica particles may be performed before or after calcining and/or activation of the beads, or at any other suitable step in the bead manufacturing process.

Next, gas to be dissolved in a beverage may be adsorbed in the beads, e.g., by exposing the activated beads to carbon dioxide or other suitable gas. The beads may adsorb 10-17% or more gas by weight and in such a way that the beads can release the gas in the presence of a suitable fluid. The coated and charged beads may then be packaged in a cartridge for use in a beverage making machine. For example, the beads may be sealed in a container suitable for use with a beverage making machine that is arranged to provide an activating fluid into the cartridge to cause gas release, and to use the released gas to carbonate a beverage. For example, the gas may be delivered in pressurized form to a carbonation tank where the gas is dissolved in a precursor liquid in the tank, such as water. The carbonation tank may be pressurized and/or chilled to increase a rate of dissolution of the gas in the liquid. In other embodiments, the gas may be dissolved in the precursor liquid in other ways, such as via an in-line carbonator, or other mechanism. The carbonated precursor liquid may be dispensed as a beverage, e.g., an amount of precursor liquid with dissolved gas may be dispensed from a carbonation tank to a user's cup as a finished beverage. In other cases, the precursor liquid and dissolved gas may be mixed with another material, such as a beverage medium, to form a beverage. Other treatments of the beverage may be used as well, such as whipping, frothing, mixing with other beverages, and so on.

A cartridge container employed in aspects of the invention may be made of any suitable materials, and is not necessarily limited to the constructions shown herein. For example, the cartridge may be made of, or otherwise include, materials that provide a barrier to moisture and/or gases, such as oxygen, water vapor, etc. In one embodiment, the cartridge may be made of a molded polymer or polymer laminate, e.g., formed from a sheet including a layer of polystyrene, polypropylene and/or a layer of EVOH and/or other barrier material, such as a metallic foil. Moreover, the cartridge materials and/or construction may vary according to the materials contained in the cartridge. For example, a portion of the cartridge 4 containing a gas source material may require a robust moisture barrier, whereas a beverage medium portion may not require such a high moisture resistance. Thus, the cartridges may be made of different materials and/or in different ways. In addition, the cartridge interior may be differently constructed according to a desired function. For example, where beverage medium is mixed with precursor liquid in the cartridge, a beverage medium cartridge portion may include baffles or other structures that cause the liquid/beverage medium to follow a tortuous path so as to encourage mixing. The gas source cartridge portion may be arranged to hold the gas source in a particular location or other arrangement in the interior space, e.g., to help control wetting of the gas source with activating liquid. Thus, as used herein, a “cartridge” may take any suitable form, such as a pod (e.g., opposed layers of filter paper encapsulating a material), capsule, sachet, package, or any other arrangement. The cartridge may have a defined shape, or may have no defined shape (as is the case with some sachets or other packages made entirely of flexible material). The cartridge may be impervious to air and/or liquid, or may allow water and/or air to pass into the cartridge. In one aspect of the invention, the cartridge or cartridges used to form a beverage using the beverage making system may have a volume that is less, and in some cases substantially less, than a beverage to be made using the cartridge(s). For example, a cartridge may have upper and lower compartments 41, 42 that each has a volume that is about 50 ml or less, and yet can be used to form a beverage having a volume of about 200-500 ml or more. In some embodiments, an amount of charged adsorbent (e.g., a charged zeolite) of about 10-50 grams (which has a volume of less than 50 ml) can be used to produce about 300-1000 ml of carbonated water having a carbonation level of up to about 4-5 volumes. Moreover, it is well known that beverage-making syrups or powders having a volume of less than about 50 ml, or less than about 100 ml, can be used to make a suitably flavored beverage having a volume of about 300-500 ml. Thus, relatively small volume cartridges (or a single cartridge in some arrangements) having a volume of about 100 ml to about 250 ml or less may be used to form a carbonated beverage having a volume of about 100 to 1000 ml, and a carbonation level of at least about 1 to 4 volumes in less than 120 seconds, e.g., about 60 seconds, and using pressures under 80 psi.

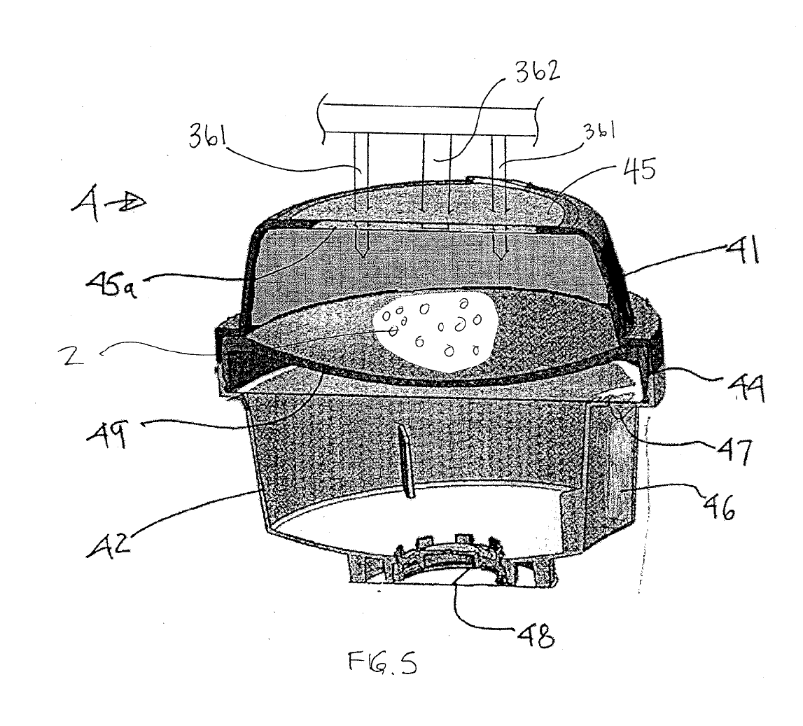

FIG. 4 shows an illustrative embodiment of a beverage making machine 1 that can employ a cartridge in accordance with one or more aspects of the invention. In this embodiment, components of the beverage making machine 1 are located in or on a housing 21 which includes a drip tray 23 to support a user's cup or other container 8 and a reservoir 11 to provide water (a precursor liquid) to make a beverage. In this case, the reservoir 11 is optionally removable from the housing 21 and contains beverage precursor liquid that is used to form a beverage dispensed at a dispensing station 29 into the user's container 8. The reservoir 11 includes a removable lid that can be removed to provide precursor liquid into the reservoir 11, but such a lid is not required. Moreover, the reservoir 11 need not be removable and/or may be replaced by a plumbed connection to a mains water source. The beverage precursor liquid can be any suitable liquid, including water (e.g., flavored or otherwise treated water, such as sweetened, filtered, deionized, softened, carbonated, etc.), or any other suitable liquid used to form a beverage, such as milk, juice, coffee, tea, etc. (whether heated or cooled relative to room temperature or not). The reservoir 11 is part of a beverage precursor supply which provides the precursor liquid for conditioning of some kind, e.g., carbonation, filtering, chilling, mixing with a beverage medium, etc., and subsequent dispensing as a beverage.

A cartridge 4 containing a gas source and/or a beverage medium may be associated with a cartridge holder 3 of the machine 1. The gas source may emit carbon dioxide or other gas which is used by the machine 1 to carbonate the precursor liquid. A beverage medium, such as a flavoring agent, may be mixed with precursor liquid as well. In this embodiment, the cartridge 4 may be associated with the cartridge holder 3 by pulling a sliding drawer 31 forwardly to expose a cartridge receiver or receiving area of the drawer 31. The cartridge 4, which in this case is arranged as in FIG. 1, may be placed in the cartridge receiving area of the drawer 31 and the drawer 31 closed by sliding to the left in FIG. 4. Thereafter, a user may interact with an interface 52, such as a touch screen, button or other device by which the user can cause the machine 1 to make a beverage. In response, the cartridge 4 may be accessed to form the beverage. As is discussed in more detail below, aspects of the invention relate to a cartridge holder's ability to hold the upper and lower compartments 41, 42 of the cartridge 4 in spaces having different pressures (e.g., the upper compartment 41 may be held in a more highly pressurized space to receive carbonating gas than the lower compartment 42) and/or the holder's ability to pierce an inlet of the lower compartment 42 at an underside of the rim or band 44 to access the beverage medium (e.g., by injecting pressurized air or other gas into the lower compartment 42, thereby forcing the beverage medium to exit the cartridge and be dispensed at the dispense station 29). Since the cartridge 4 may be replaceable, a user may exchange the cartridge 4 to make different beverages, such as carbonated water only, a carbonated and flavored beverage, a still and flavored beverage, etc.

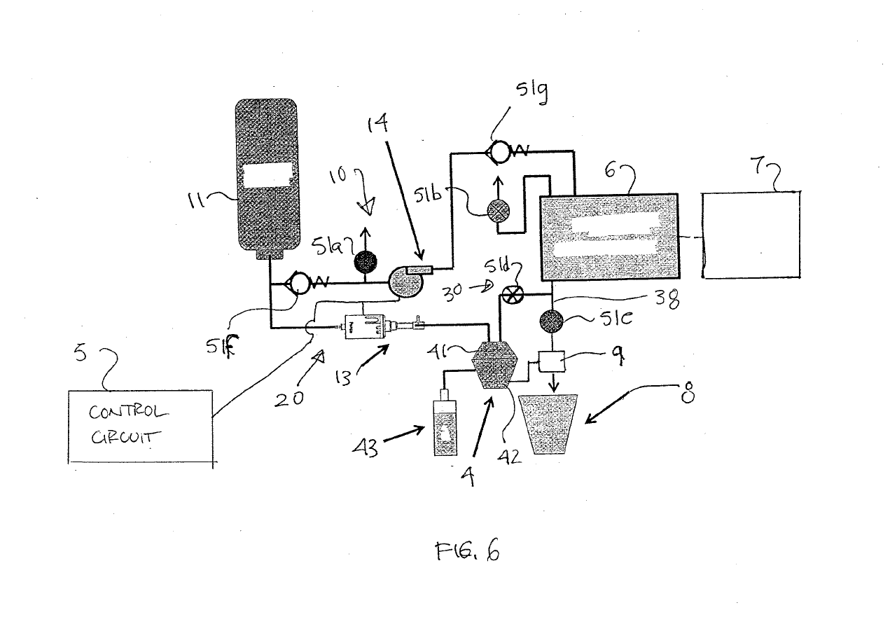

FIG. 5 shows an illustrative embodiment for accessing the upper compartment 41 of the cartridge 4 when the cartridge 4 is held in the cartridge holder 3 of the beverage making machine 1. In this arrangement, one or more piercing elements 361 may pierce the lid 45 to introduce activating fluid into the upper compartment 41, and a piercing element 362 may pierce the lid 45 to allow gas emitted by the gas source to exit the cartridge 4. Though not necessary, the piercing elements 361 are arranged to penetrate through the lid 45 and the filter 45a so that activating fluid can be introduced below the filter 45a. However, the piercing element 362 is arranged to pierce only the lid 45, but not the filter 45a. In this way, gas emitted in the upper compartment 41 by the gas source material 2 must pass through the filter 45a before exiting to the carbonating gas supply. This may help prevent gas source material, such as zeolite particles, from exiting the cartridge 4 and passing to the precursor liquid or portions of the machine 1. A variety of arrangements are possible for the filter 45a, such as a piece of filter paper mentioned above, a hydrophobic non-woven material that permits gas to pass, but resists liquid passage, or other element that permits gas to exit the cartridge 4, but resists movement of gas source material and/or liquid. In addition or alternately to the filter 45a, a conduit that receives the carbonating gas may include a filter element, such as a filter plug in the conduit, to help further resist movement of gas source materials from the cartridge 4. The piercing elements, may include a hollow needle, spike, blade, knife or other arrangement, to form a suitable opening in the cartridge 4. In this embodiment, the piercing elements 361 include tubular elements with an activating fluid discharge opening at a distal end such that activating fluid can be released from the piercing elements 361 below the filter 45a. In contrast, the piercing element 362 is relatively dull so as to penetrate the lid 45, but not the filter 45a. Alternately, the cartridge 4 may have defined openings, e.g., one or more ports, that include a septum or other valve-type element that permits flow into and/or out of the cartridge 4.

While a beverage making machine 1 may employ different liquid and gas flow path arrangements, FIG. 6 shows one such arrangement that may be used in the beverage making machine 1. In this embodiment, precursor liquid provided by a precursor liquid supply 10 originates in the reservoir 11, which may be removable from the machine 1, e.g., to allow for easier filling, or may be fixed in place. Although in this embodiment a user initially provides the beverage precursor liquid in the reservoir 11, the precursor supply 10 may include other components to provide liquid to the reservoir 11, such as a plumbed water line, controllable valve, and liquid level sensor to automatically fill the reservoir 11 to a desired level, a second water reservoir or other tank that is fluidly connected to the reservoir 11, and other arrangements. Liquid is delivered by a pump 14 to the carbonation tank 6 via a check valve 51f upstream of the pump 14 and a check valve 51g downstream of the pump 14. The check valves 51f, 51g may help prevent backflow from the carbonation tank 6, e.g., when the tank 6 is relatively highly pressurized during the carbonating process. In this instance, the pump 14 is a diaphragm pump, but other pump types are possible. The carbonation tank 6 may be suitably filled with liquid using any suitable control method, such as by sensing a level in the tank 6 using a conductive probe, pressure sensor, optical sensor or other sensor. A tank vent valve 51b may be opened during filling to allow the pressure in the tank 6 to vent, or may remain closed during filling, e.g., to allow a pressure build up in the tank 6. An activating fluid supply 20 which includes a pump 13 is arranged to provide activating fluid to the upper compartment of the cartridge 4, i.e., to cause the gas source material 2 to release gas to the carbonation tank 6. Gas emitted by the cartridge 4 is routed to the tank 6 via a valve 51d. A control circuit 5 may control operation of the valves 51, e.g., the valves 51 may include electromechanical or other actuators, as well as include sensors to detect various characteristics, such as temperature in the tank 6, pressure in the tank 6, a flow rate of gas or liquid in any of the system flow lines, etc.

To form a beverage, a user may associate a cartridge 4 with the machine 1, e.g., by loading the cartridge 4 into a cartridge holder 3 in a way like that discussed with respect to FIG. 4. Of course, a cartridge may be associated with the machine 1 in other ways, such as by screwing a portion of the cartridge into engagement with the machine 1, etc. With the cartridge 4 associated with the machine 1, the control circuit 5 may then activate the machine 1 to deliver liquid to the cartridge 4, e.g., to cause carbon dioxide to be generated to be released. (Though this embodiment uses a cartridge with a gas source activated by a fluid, other arrangements are possible.) The control circuit 5 may start operation of the machine 1 in an automated way, e.g., based on detecting the presence of a cartridge 4 in the holder 3, detecting liquid in the carbonation tank 6 and closure of the holder 3, and/or other characteristics of the machine 1. Alternately, the control circuit 5 may start system operation in response to a user interacting with an interface 52, e.g., pressing a start button or otherwise providing input (e.g., by voice activation) to start beverage preparation. To initiate carbonation after the tank is provided with a suitable amount of precursor liquid, the vent valve 51b may be closed and the pump 13 controlled to pump liquid into the upper compartment 41 of a cartridge 4 that contains a gas source 2. That is, the machine 1 may include a carbon dioxide activating fluid supply 20 that provides a fluid, e.g., in a controlled volume, at a controlled rate or otherwise to control a gas production rate, to a cartridge 4 so as to activate a carbon dioxide source in the upper compartment 41 to release carbon dioxide gas. In this embodiment, the carbon dioxide source includes a charged adsorbent or molecular sieve, e.g., a zeolite material that has adsorbed some amount of carbon dioxide gas that is released in the presence of water, whether in vapor or liquid form. Other arrangements or additions are possible for the carbon dioxide activating fluid supply 20, such as a dedicated liquid supply for the cartridge 4 that is separate from the precursor liquid supply, a pressure-reducing element in the conduit, a flow-restrictor in the conduit, a flow meter to indicate an amount and/or flow rate of fluid into the cartridge 4, a syringe, piston pump or other positive displacement device that can meter desired amounts of liquid (whether water, citric acid or other material) to the cartridge 4, and others. In another embodiment, the activating fluid supply 20 may include a gravity fed liquid supply that has a controllable delivery rate, e.g., like the drip-type liquid supply systems used with intravenous lines for providing liquids to hospital patients, or may spray atomized water or other liquid to provide a water vapor or other gas phase activating fluid to the cartridge 4.

A carbon dioxide gas supply 30 may be arranged to provide carbon dioxide gas from the cartridge 4 to an area where the gas is used to carbonate the liquid, in this case, the carbonation tank 6. The gas supply 30 may be arranged in any suitable way, and in this illustrative embodiment includes a conduit that is fluidly connected between the cartridge 4 and a carbonated liquid outlet of the carbonation tank 6. A gas control valve 51d is controllable by the control circuit 5 to open and close the flow path through the gas supply conduit. (Note that in some embodiments, the valve 51d may be a check valve that is not controllable by the control circuit 5.) In accordance with an aspect of the invention, the carbonation gas is delivered via a carbonating gas supply line that is fluidly coupled to the dispense line of the carbonation tank so as to deliver carbon dioxide gas to the outlet of the carbonation tank to carbonate the precursor liquid. This arrangement may provide advantages, such as introducing the carbonating gas at a relatively low point in the tank, which may help increase contact of the gas with the precursor liquid, thereby enhancing dissolution of the gas. In addition, the flow of carbonating gas through at least a portion of the dispense line 38 may help purge the dispense line 38 of liquid, helping to re-carbonate the liquid, if necessary. The gas conduit may be connected to the dispense line 38 close to the dispense valve 51e so as to purge as much liquid from the dispense line 38 as possible.

The gas supply 30 may include other components than a conduit and valve, such as pressure regulators, safety valves, additional control valves, a compressor or pump (e.g., to increase a pressure of the gas), an accumulator (e.g., to help maintain a relatively constant gas pressure and/or store gas), and so on. (The use of an accumulator or similar gas storage device may obviate the need to control the rate of gas output by a cartridge. Instead, the gas source may be permitted to emit gas in an uncontrolled manner, with the emitted gas being stored in an accumulator for later delivery and use in producing a sparkling beverage. Gas released from the accumulator could be released in a controlled manner, e.g., at a controlled pressure and/or flow rate.) Also, carbonation and flavoring of the precursor liquid may occur via one or more mechanisms or processes, and thus is not limited to one particular process. For example, while delivery of carbon dioxide gas to the outlet of the carbonation tank 6 may function to help dissolve carbon dioxide in the liquid, other system components may further aid in the carbonation process. In some embodiments, a sparger may be used to introduce gas into the carbonation tank, precursor liquid may be circulated in the tank, and/or other techniques may be used to alter a rate at which carbonating gas is dissolved.

Before, during and/or after carbonation of the liquid in the carbonation tank 6, a cooling system 7 may chill the liquid. The cooling system 7 may operate in any suitable way, e.g., may include ice, refrigeration coils or other cooling elements in thermal contact with the carbonation tank 6. In addition, the carbonation tank 6 may include a mixer or other agitator to move the liquid in the tank 6 to enhance gas dissolution and/or cooling. Operation in forming a beverage may continue for a preset amount of time, or based on other conditions, such as a detected level of carbonation, a drop in gas production by the cartridge 4, or other parameters. During operation, the amount of liquid provided to the cartridge 4 may be controlled to control gas output by the cartridge 4. Control of the liquid provided to the cartridge 4 may be made based on a timing sequence (e.g., the pump may be operated for a period of time, followed by stoppage for a period, and so on), based on detected pressure (e.g., liquid supply may be stopped when the pressure in the tank 6 exceeds a threshold, and resume when the pressure falls below the threshold or another value), based on a volume of activating liquid delivered to the holder 3 (e.g., a specific volume of liquid may be delivered to the cartridge 4 in one or more discrete volumes), or other arrangements.

With the precursor liquid in the carbonation tank 6 ready for dispensing, the vent valve 51b may be opened to reduce the pressure in the carbonation tank 6 to an ambient pressure. As is known in the art, depressurizing the carbonation tank prior to dispensing may aid in maintaining a desired carbonation level of the liquid during dispensing. With the tank 6 vented, the vent valve 51b may be closed and a pump vent valve 51a may be opened. The pump 14 may then be operated to draw air or other gas into the inlet side of the pump 14 and pump the gas into the carbonation tank 6 so as to force the precursor liquid in the tank 6 to flow into the dispense line 38. That is, the arrangement of FIG. 6 incorporates another aspect of the invention in that a single pump may be used to both deliver precursor liquid to a carbonation tank or other carbonation location as well as deliver pressurized gas (air) to the carbonation tank to dispense carbonated liquid from the tank. This feature, optionally combined with the feature of using the same pump to deliver activating fluid to a gas source, may make for a simplified system with fewer components. While the pump 14 delivers air to the carbonation tank, the dispense valve 51e is opened and the gas valve 51d is closed during liquid dispensing. The dispensed liquid may enter a mixing chamber 9 at which the carbonated liquid and beverage medium provided from the lower compartment 42 of the cartridge 4 are combined. The beverage medium may be moved out of the cartridge 4 and to the mixing chamber 9 by introducing pressurized gas into the lower compartment 42, e.g., by way of an air pump 43. Other arrangements are possible, however, such as routing gas from the upper compartment 41 under pressure to the lower compartment 42.

The beverage medium may include any suitable beverage making materials (beverage medium), such as concentrated syrups, ground coffee or liquid coffee extract, tea leaves, dry herbal tea, powdered beverage concentrate, dried fruit extract or powder, natural and/or artificial flavors or colors, acids, aromas, viscosity modifiers, clouding agents, antioxidants, powdered or liquid concentrated bouillon or other soup, powdered or liquid medicinal materials (such as powdered vitamins, minerals, bioactive ingredients, drugs or other pharmaceuticals, nutriceuticals, etc.), powdered or liquid milk or other creamers, sweeteners, thickeners, and so on. (As used herein, “mixing” of a liquid with a beverage medium includes a variety of mechanisms, such as the dissolving of substances in the beverage medium in the liquid, the extraction of substances from the beverage medium, and/or the liquid otherwise receiving some material from the beverage medium.)

The control circuit 5 may use one or more sensors to control a carbonation level of the precursor liquid, a temperature to which the liquid is chilled (if at all), a time at which and during which beverage medium is delivered to the mixing chamber 9, a rate at which carbonating gas is produced and delivered to the tank 6, and/or other aspects of the beverage making process. For example, a temperature sensor may detect the temperature of the precursor liquid in the carbonation tank 6. This information may be used to control system operation, e.g., warmer precursor liquid temperatures may cause the control circuit 5 to increase an amount of time allowed for carbon dioxide gas to be dissolved in the precursor liquid. In other arrangements, the temperature of the precursor liquid may be used to determine whether the machine 1 will be operated to carbonate the liquid or not. For example, in some arrangements, the user may be required to add suitably cold liquid (and/or ice) to the reservoir 11 before the machine 1 will operate. (As discussed above, relatively warm precursor liquid temperatures may cause the liquid to be insufficiently carbonated in some conditions.) In another embodiment, a pressure sensor may be used to detect a pressure in the carbonation tank 6. This information may be used to determine whether the carbonation tank 6 is properly or improperly filled, if a pressure leak is present, if carbonation is complete and/or to determine whether sufficient carbon dioxide gas is being produced by the cartridge 4. For example, low detected pressure may indicate that more carbon dioxide needs to be generated, and thus cause the control circuit 5 to allow more liquid to be delivered by the activating fluid supply 20 to the cartridge 4. Likewise, high pressures may cause the flow of liquid from the activating fluid supply 20 to be slowed or stopped. Thus, the control circuit 5 can control the gas pressure in the carbonation tank 6 and/or other areas of the machine 1 by controlling an amount of liquid delivered to the cartridge 4. Alternately, low pressure may indicate that there is a leak in the system and cause the system to indicate an error is present. In some embodiments, measured pressure may indicate that carbonation is complete. For example, pressure in the tank 6 may initially be detected to be at a high level, e.g., around 70-80 psi, and later be detected to be at a low level, e.g., around 40 psi due to gas being dissolved in the liquid. The low pressure detection may indicate that carbonation is complete. A sensor could also detect the presence of a cartridge 4 in the cartridge holder 3, e.g., via RFID tag, optical recognition, physical sensing, etc. If no cartridge 4 is detected, or if the control circuit 5 detects that the cartridge 4 is spent, the control circuit 5 may prompt the user to insert a new or different cartridge 4. For example, in some embodiments, a single cartridge 4 may be used to carbonate multiple volumes of precursor liquid. The control circuit 5 may keep track of the number of times that the cartridge 4 has been used, and once a limit has been reached (e.g., 10 drinks), prompt the user to replace the cartridge. Other parameters may be detected by a sensor, such as a carbonation level of the precursor liquid (which may be used to control the carbonation process), the presence of a suitable vessel to receive a beverage discharged from the machine 1 (e.g., to prevent beverage from being spilled), the presence of water or other precursor liquid in the carbonation tank 6 or elsewhere in the precursor supply 10, a flow rate of liquid in the pump 13 or associated conduit, the presence of a headspace in the carbonation tank 6 (e.g., if no headspace is desired, a valve may be activated to discharge the headspace gas, or if only carbon dioxide is desired to be in the headspace, a snifting valve may be activated to discharge air in the headspace and replace the air with carbon dioxide), and so on.

The control circuit 5 may also be arranged to allow a user to define a level of carbonation (i.e., amount of dissolved gas in the beverage, whether carbon dioxide or other). For example, the control circuit 5 may include a touch screen display or other user interface 52 that allows the user to define a desired carbonation level, such as by allowing the user to select a carbonation volume level of 1, 2, 3, 4 or 5, or selecting one of a low, medium or high carbonation level. Cartridges used by the machine 1 may include sufficient gas source material to make the highest level of carbonation selectable, but the control circuit 5 may control the system to dissolve an amount of gas in the beverage that is consistent with the selected level. For example, while all cartridges may be arranged for use in creating a “high” carbonation beverage, the control circuit 5 may operate the machine 1 to use less of the available gas (or cause the gas source to emit less gas than possible) in carbonating the beverage. Carbonation levels may be controlled based on a detected carbonation level by a sensor, a detected pressure in the carbonation tank 6 or elsewhere, an amount of gas output by the cartridge 4, or other features.

As noted above, by arranging the gas source and/or providing activating fluid to the gas source in a controlled way, the rate at which adsorbed gas is released may be suitably controlled. This feature can make the use of some gas sources, such as a charged zeolite material, possible without requiring gas storage or high pressure components. For example, zeolites charged with carbon dioxide tend to release carbon dioxide very rapidly and in relatively large quantities (e.g., a 30 gram mass of charged zeolite can easily produce 1-2 liters of carbon dioxide gas at atmospheric pressure in a few seconds in the presence of less than 30-50 ml of water). This rapid release can in some circumstances make the use of zeolites impractical for producing relatively highly carbonated liquids, such as a carbonated water that is carbonated to a level of 2 volumes or more. That is, dissolution of carbon dioxide or other gases in liquids typically takes a certain amount of time, and the rate of dissolution can only be increased a limited amount under less than extreme conditions, such as pressures within about 150 psi of ambient and temperatures within about +/−40 to 50 degrees C. of room temperature. By controlling the rate of carbon dioxide (or other gas) production for a carbon dioxide (or other gas) source, the total time over which the carbon dioxide (or other gas) source emits carbon dioxide (or other gas) can be extended, allowing time for the carbon dioxide (gas) to be dissolved without requiring relatively high pressures. For example, when employing one illustrative embodiment incorporating one or more aspects of the invention, the inventors have produced liquids having at least up to about 3.5 volume carbonation levels in less than 60 seconds, at pressures under about 40 psi, and at temperatures around 0 degrees Celsius. This capability allows for a carbonated beverage machine to operate at relatively modest temperatures and pressures, potentially eliminating the need for relatively expensive high pressure tanks, conduits and other components, as well as extensive pressure releases, containment structures and other safety features that might otherwise be required, particularly for a machine to be used in the consumer's home. Of course, as discussed above and elsewhere herein, aspects of the invention are not limited to use with carbon dioxide, and instead any suitable gas may be dissolved in a liquid in accordance with all aspects of this disclosure.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A cartridge for use by a beverage forming machine in forming a beverage, comprising:
a container including a first chamber that is sealed and encloses,
a gas source material arranged to release a gas adsorbed by the gas source material with the addition of a fluid introduced into the first chamber, the gas source material including beads of a solid molecular sieve, the beads each having a coating of fumed or precipitated silica particles;
wherein the container is arranged to have an inlet through which the fluid is introducible by the beverage forming machine into the first chamber to cause the gas source material to release the gas, and is arranged to have an outlet through which gas released by the gas source exits the first chamber for dissolution in a beverage.

2. The cartridge of claim 1, wherein the coating of fumed or precipitated silica particles provides the beads with a turbidity measurement of 20 NTU or less.

3. The cartridge of claim 1, wherein the beads have a gas adsorption capacity of at least 10%.

4. The cartridge of claim 1, wherein the beads have a coating of fumed silica particles having a size of 7 nm to 200 nm.

5. The cartridge of claim 1, wherein the coating of fumed or precipitated silica particles is applied to the beads in an aqueous solution in which fumed or precipitated silica particles are mixed with water.

6. The cartridge of claim 1, wherein the coating of fumed or precipitated silica particles is applied to the beads by wetting the beads with water and applying dry fumed or precipitated silica particles to wetted beads.

7. The cartridge of claim 1, wherein a weight of the coating of fumed or precipitated silica particles on each bead is 0.5% to 5.0% of a weight of the bead.

8. The cartridge of claim 1, wherein the beads each have a size of 0.5 to 2.5 mm.

9. The cartridge of claim 1, wherein a ratio of a mass of adsorbed gas to a mass of the beads is at least 15%, and wherein the beads are each arranged to release at least 95% of all adsorbed gas within 60 seconds when immersed in water.

10. The cartridge of claim 1, wherein the gas source material has an amount of adsorbed gas equivalent to a volume of 300 ml to 2000 ml of the gas at atmospheric pressure.

11. The cartridge of claim 1, wherein the coating of fumed or precipitated silica particles is applied after calcining of the beads.

12. The cartridge of claim 1, wherein the beads have a BET surface area of at least 80 square meters/gram.

13. The cartridge of claim 1, wherein the beads include an aluminosilicate zeolite.

14. A method of forming beads of a molecular sieve for adsorbing gas to be dissolved in a beverage, comprising:
providing solid beads of a molecular sieve;
coating the beads with particles of fumed or precipitated silica;
adsorbing gas to be dissolved in a beverage in the beads; and
packaging the coated beads in a cartridge for use in a beverage making machine.

15. The method of claim 14, wherein the coating of fumed or precipitated silica particles provides the beads with a turbidity measurement of 20 NTU or less.

16. The method of claim 14, wherein the beads have a gas adsorption capacity of at least 10%.

17. The method of claim 14, wherein the coating includes fumed silica particles having a size of 7 nm to 200 nm.

18. The method of claim 14, wherein the step of coating includes applying the fumed or precipitated silica to the beads in an aqueous solution in which fumed or precipitated silica particles are mixed with water.

19. The method of claim 14, wherein the step of coating includes applying fumed or precipitated silica particles to the beads by wetting the beads with water and applying dry fumed or precipitated silica particles to wetted beads.

20. The method of claim 14, wherein a weight of the coating of fumed or precipitated silica particles on each bead is 0.5% to 5.0% of a weight of the bead.

21. The method of claim 14, wherein the beads each have a size of 0.5 to 2.5 mm.

22. The method of claim 14, wherein a ratio of a mass of adsorbed gas to a mass of the beads is at least 15%, and wherein the beads are each arranged to release at least 95% of all adsorbed gas within 60 seconds when immersed in water.

23. The method of claim 14, wherein the gas source material has an amount of adsorbed gas equivalent to a volume of 300 ml to 2000 ml of the gas at atmospheric pressure.

24. The method of claim 14, wherein the coating of fumed or precipitated silica particles is applied after calcining of the beads.

25. The method of claim 14, wherein the beads have a BET surface area of of at least 80 square meters/gram.

26. The method of claim 14, wherein the beads include an aluminosilicate zeolite.
